(19) United States
(12) Patent Application Publication
(10) Pub. No.: US 2010/0275023 A1
(43) Pub. Date: Oct. 28, 2010

(54) TRANSMITTER, RECEIVER, AND CONTENT TRANSMITTING AND RECEIVING METHOD

(75) Inventors: Yoshinobu FUJIWARA, Tokyo (JP); Kunio HONSAWA, Tokyo (JP); Atsushi NAKAJIMA, Tokyo (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/687,618

(22) Filed: Jan. 14, 2010

(30) Foreign Application Priority Data
Apr. 24, 2009 (JP) 2009-106725

(51) Int. Cl. H04L 9/32

(52) U.S. Cl. 713/171

(57) ABSTRACT

According to one embodiment, a transmitter configured to transmit content to a receiver. Available dubbing count is set in advance for the content such that the content can be dubbed a plurality of times. The transmitter includes a key exchanger, an encryption processor, and a management module. The key exchanger performs key exchange to share a common key with the receiver, and transmits the common key and at least one count label corresponding to the number of times of dubbing to the receiver. The encryption processor encrypts, in response to a content request for the content received from the receiver, the content with the common key to transmit the content to the receiver. The management module reduces the available dubbing count of the content upon each receipt of a right transfer request requesting to transfer right to use the content from the receiver, and transmits permission to the receiver to validate the right to use the content.

### CROSS-REFERENCE TO RELATED APPLICATIONS

This application is based upon and claims the benefit of priority from Japanese Patent Application No. 2009-106725, filed Apr. 24, 2009, the entire contents of which are incorporated herein by reference.

### BACKGROUND

1. Field

One embodiment of the invention relates to a transmitter that transmits content, a receiver that receives content, and a content transmitting and receiving method.

2. Description of the Related Art

With widespread of computer networks such as broadband networks and wireless local area networks (LANs), digital information devices, digital home appliances, etc. having a communication function have been increasingly used. If a plurality of digital home appliances are connected to a network, the user can enjoy content via the network. The “content” refers to various types of digital data including, for example, MPEG-2 and MPEG-4 video data and audio data, document data such as text data and image data, and the like. Although content made up of such digital data can easily be copied without loss of quality, attention has to be paid to the issue of copyright of the content.

For example, in Japanese digital broadcasting services, it is defined that a total of up to ten contents received by a recorder through broadcast waves are allowed to be stored in the internal device (see, for example, “The Association for Promotion of Digital Broadcasting,” “the Outline of Changes in the Dubbing 10 Rule,” on line, retrieved on Apr. 9, 2009, the Internet <URL: http://www.dpa.or.jp/images/news/dub10-outline.pdf>). Digital transmission content protection (DTCP) and digital transmission content protection over Internet protocol (DTCP-IP) are commonly used to output content from a transmitter to a receiver via an in-home network while protecting the content. As to DTCP, reference may be had to “Digital transmission Licensing Administer,” “Digital Transmission Content Protection Specification Volume 1 Revision 1.51,” on line, retrieved on Apr. 9, 2009, the Internet <URL: http://www.dtcp.com/data/info%2020071001%20DTCP%20V1%201p51.pdf>). As to DTCP-IP, reference may be had to “Digital transmission Licensing Administer,” “DTCP Volume 1 Supplement E Mapping DTCP to IP, Revision 1.2,” on line, retrieved on Apr. 9, 2009, the Internet <URL: http://www.dtcp.com/data/info%2020070615%20DTCP%20V1SE%201p2.pdf>). Hereinafter, DTCP and DTCP-IP are both referred to as DTCP-IP. For example, Japanese Patent Application Publication (KOKAI) No. 2005-301449 discloses a conventional content transmitter that transmits content according to the DTCP-IP standard.

According to DTCP-IP, for simultaneously dubbing content received through a broadcast wave on a plurality of receivers, a different common key dedicated to dubbing is required for each of the receivers, and the content needs to be encrypted with the different common key to be transmitted to each of the receivers. Besides, for dubbing content on a receiver a plurality of times, a different common key dedicated to dubbing is required for each dubbing, and the content needs to be encrypted with the different common key to be transmitted to the receiver for each time of dubbing. As a result, a transmitter requires a large amount of resources upon encrypting content.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration of a content transmitting/receiving system according to a first embodiment of the invention;

FIG. 2 is an exemplary functional block diagram of a transmitter in the first embodiment;

FIG. 3 is an exemplary table of content-related information managed by a key/label management module illustrated in FIG. 2 in the first embodiment;

FIG. 4 is an exemplary functional block diagram of a receiver illustrated in the first embodiment;

FIG. 5 is an exemplary table of content-related information managed by a key/label management module illustrated in FIG. 4 in the first embodiment;

FIG. 6 is an exemplary sequence diagram of the operation of the content transmitting/receiving system in the first embodiment;

FIG. 7 is an exemplary flowchart of the operation of the transmitter in the first embodiment;

FIG. 8 is an exemplary flowchart of the operation of the receiver in the first embodiment;

FIG. 9 is an exemplary sequence diagram of the process of dubbing the same content from one transmitter to two receivers in the first embodiment;

FIG. 10 is an exemplary functional block diagram of a transmitter according to a second embodiment of the invention;

FIG. 11 is an exemplary sequence diagram of the operation of a content transmitting/receiving system in the second embodiment; and

FIG. 12 is an exemplary block diagram of a hardware configuration of an information processor according to an embodiment of the invention.

### DETAILED DESCRIPTION

Various embodiments according to the invention will be described hereinafter with reference to the accompanying drawings. In general, according to one embodiment of the invention, a transmitter is configured to transmit content to a receiver. Available dubbing count is set in advance for the content such that the content can be dubbed a plurality of times. The transmitter comprises a key exchanger, an encryption processor, and a management module. The key exchanger is configured to perform key exchange to share a common key with the receiver, and transmit the common key and at least one count label corresponding to the number of times of dubbing to the receiver. The encryption processor is configured to encrypt, in response to a content request for the content received from the receiver, the content with the common key to transmit the content to the receiver. The management module is configured to reduce the available dubbing count of the content upon each receipt of a right transfer request requesting to transfer right to use the content from the receiver, and transmit permission to the receiver to validate the right to use the content.

According to another embodiment of the invention, a receiver is configured to receive content from a transmitter. Available dubbing count is set in advance for the content such that the content can be dubbed a plurality of times. The receiver comprises a key exchanger, an encryption processor, and a management module. The key exchanger is configured to perform key exchange to share a common key with the transmitter, and receive the common key and at least one count label corresponding to the number of times of dubbing from the transmitter. The encryption processor is configured to transmit a content request for the content to the transmitter and, upon receipt of the content encrypted by the transmitter from the transmitter, decrypt the content with the common key. The management module is configured to transmit a right transfer request requesting to transfer right to use the content to the transmitter, and increase the available dubbing count of the content upon each receipt of permission to validate the right to use the content from the transmitter. The number of the right transfer request corresponds to the number of the count label received by the key exchanger.

According to another embodiment of the invention, there is provided a content transmitting and receiving method applied to a transmitter and a receiver that communicate content. Available dubbing count is set in advance for the content such that the content can be dubbed a plurality of times. The content transmitting and receiving method comprises: the transmitter performing key exchange to share a common key with the receiver, and transmitting the common key and at least one count label corresponding to the number of times of dubbing to the receiver; the transmitter transmitting the content encrypted with the common key to the receiver in response to a content request for the content received from the receiver; the transmitter reducing the available dubbing count of the content upon each receipt of a right transfer request requesting to transfer right to use the content from the receiver, and transmitting permission to the receiver to validate the right to use the content; the receiver receiving the common key and the count label transmitted from the transmitter; the receiver transmitting the content request to the transmitter and, upon receipt of the content encrypted by the transmitter from the transmitter, decrypting the content with the common key; and the receiver transmitting the right transfer request to the transmitter, and increasing the available dubbing count of the content upon each receipt of permission to validate the right to use the content from the transmitter. The number of the right transfer request corresponds to the number of the count label received.

In a content transmitting/receiving system according to an embodiment of the invention, content is moved or copied from a content transmitter (hereinafter, “transmitter”) to a content receiver (hereinafter, “receiver”). It is assumed herein that, when content is moved from the transmitter, the transmitter invalidates (deletes, etc.) the content after transmitting the content. Thus, the content uniquely exists in the system. On the other hand, when content is copied, the transmitter does not invalidate the content after transmitting the content. Accordingly, a plurality of the same contents exist in the system. Hereinafter, “move” and “copy” will be collectively referred to as “dubbing”. It is also assumed herein that available number of times of dubbing is preset to content as available dubbing count.

The term “content” as used herein refers to digital data that requires copyright protection, i.e., digital content that needs to be protected by copyright when transmitted. It is assumed herein that “digital data that requires copyright protection” is encrypted when transmitted from the transmitter to the receiver.

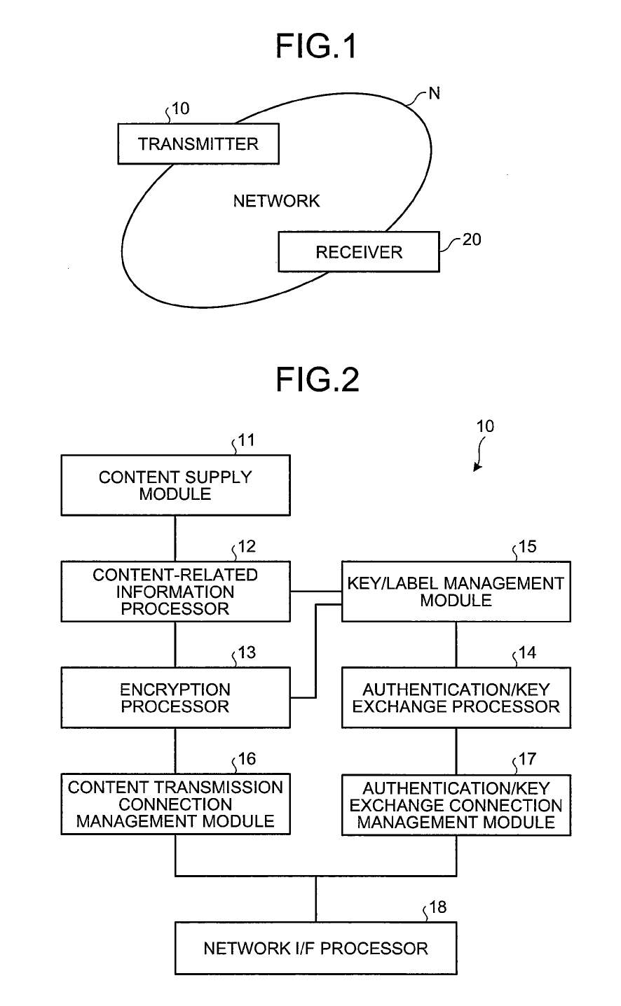

FIG. 1 is a schematic diagram of a configuration of the content transmitting/receiving system according to a first embodiment of the invention. As illustrated in FIG. 1, the content transmitting/receiving system comprises a transmitter 10 and a receiver 20. The transmitter 10 is connected to the receiver 20 via a network N. Examples of the network N include wired networks such as Ethernet®, IEEE 1394, and universal serial bus (USB), and wireless networks such as IEEE 802.11, Bluetooth®. Although only the transmitter 10 and the receiver 20 one each are connected to the network N in the example of FIG. 1, any number of them may be connected to the network N. Further, a device other than the transmitter 10 and the receiver 20 may be connected to the network N.

In response to a dubbing request, i.e., a request for dubbing of content, the transmitter 10 transmits the contend to the receiver 20 while protecting the right© related to the use (dubbing) of the content. The receiver 20 receives the content from the transmitter 10 via the network N. Communication related to the dubbing of content is performed according to DTCP-IP between the transmitter 10 and the receiver 20. In the following, a description will be given of a functional configuration of each device that constitutes the content transmitting/receiving system.

FIG. 2 is a functional block diagram of the transmitter 10. As illustrated in FIG. 2, the transmitter 10 comprises a content supply module 11, a content-related information processor 12, an encryption processor 13, an authentication/key exchange processor 14, a key/label management module 15, a content transmission connection management module 16, an authentication/key exchange connection management module 17, and a network interface (I/F) processor 18.

The content supply module 11 stores content of plain text in a storage module 106, which will be described later, or the like and reads content to be dubbed in response to a dubbing request to supply the content to the content-related information processor 12. The dubbing request may include, in addition to content identification information that uniquely identifies the content to be dubbed, dubbing count indicating the number of times of dubbing of the content, a receiver ID (for example, Internet protocol (IP) address, etc.) for identifying the receiver 20 that has transmitted the dubbing request.

The content-related information processor 12 outputs the content to be dubbed received from the content supply module 11 to the encryption processor 13. Besides, the content-related information processor 12 notifies the key/label management module 15 of information related to the content to be dubbed, such as available dubbing count indicating the number of times the content can be dubbed.

Further, the content-related information processor 12 reduces the available dubbing count of the content to be dubbed by the number of count labels notified by the key/label management module 15. If the available dubbing count becomes 0 (zero), the content-related information processor 12 disables the use of the content.

The encryption processor 13 encrypts the content to be dubbed using a common key shared with the receiver 20. Hereinafter, content encrypted by the encryption processor 13 will be referred to as “encrypted content”.

The authentication/key exchange processor 14 performs authentication/key exchange process with the receiver 20 to generate a common key to encrypt content and a key label that identifies the common key, thereby transmitting them to the receiver 20 together with count labels of the same number as the number of times of dubbing.

The authentication/key exchange processor 14 notifies the key/label management module 15 of a right transfer request from the receiver 20. The authentication/key exchange processor 14 also transmits information such as right transfer permission or right transfer denial notified by the key/label management module 15 to the receiver 20.

In the authentication/key exchange process, the transmitter 10 authenticates the receiver 20 as a device properly licensed by a specific license organization, and vice versa. If the transmitter 10 and the receiver 20 are both authenticated as licensed devices, a common key is generated. That is, when the authentication/key exchange process is successful, the transmitter 10 and the receiver 20 can share a common key used to encrypt or decrypt content. The authentication can be performed by a commonly known method based on, for example, international organization for standardization/international electrotechnical commission (ISO/IEC) 9798-2 or ISO/IEC 9798-3. As an encryption algorithm to encrypt or decrypt content can be used a commonly known one such as advanced encryption standard (AES) algorithm.

The key/label management module 15 receives available dubbing count of the content to be dubbed from the content-related information processor 12 and manages it as count labels. More specifically, the key/label management module 15 generates count labels of the number corresponding to the available dubbing count. Incidentally, a value is set to each of the count labels to identify it.

The key/label management module 15 also receives from the authentication/key exchange processor 14 a common key and a key label related to the content to be dubbed transmitted from the receiver 20. The key/label management module 15 associates the common key and the key label with count labels of corresponding content and manages them as content-related information. The key label is information that uniquely identifies the common key. The key label may be generated by the authentication/key exchange processor 14 upon generation of the common key or may be generated by the key/label management module 15 upon registration of the common key.

Further, upon receipt of a right transfer request from the receiver 20 through the authentication/key exchange processor 14, based on a count label and the message authentication code (MAC) value of the count label contained in the right transfer request, the key/label management module 15 verifies or checks the validity of the count label. Having checked the validity of the count label, i.e., when the count label is valid, the key/label management module 15 notifies the content-related information processor 12 of the count label to reduce the available dubbing count of the content to be dubbed by the number of the count label.

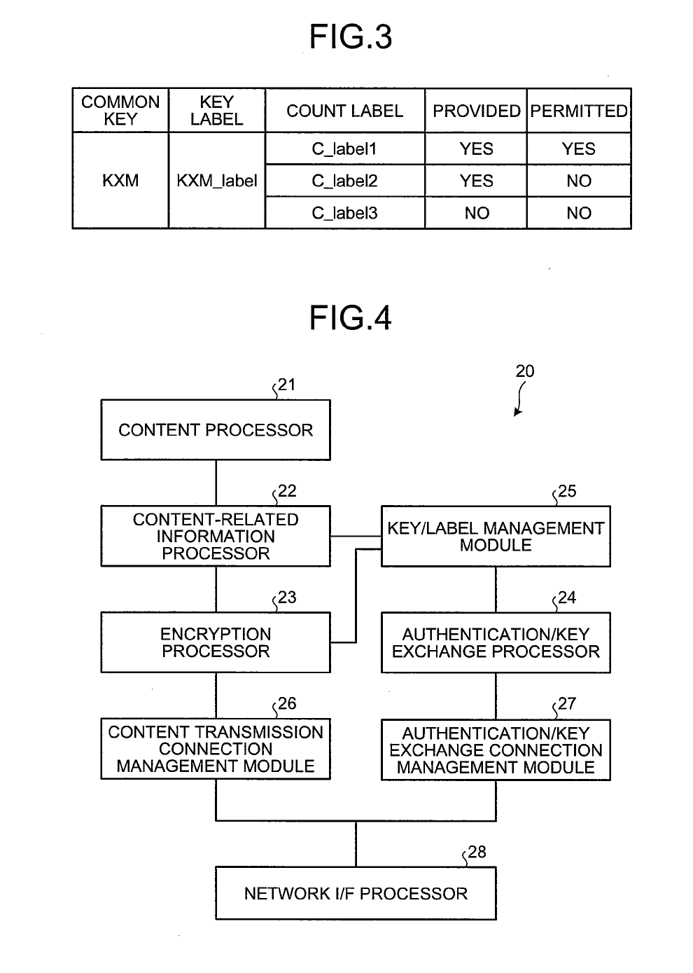

FIG. 3 illustrates an example of content-related information managed by the key/label management module 15. As illustrated in FIG. 3, with respect to content to be dubbed, the key/label management module 15 associates “common key” generated by the authentication/key exchange processor 14, “key label” that identifies the common key, and “count label” corresponding to the available dubbing count of the content with one another and manages them as content-related information. Incidentally, the key/label management module 15 may manage the above information further in association with content identification information (for example, content name, etc.) that identifies the content to be dubbed.

In the example of FIG. 3, available dubbing count is “3”, and the key/label management module 15 manages three count labels (C_label1, C_label2, and C_label3) corresponding to the available dubbing count “3”. The key/label management module 15 may implements the management of count labels when notified of available dubbing count by the content-related information processor 12 or when notified of a dubbing request by the authentication/key exchange processor 14.

In FIG. 3, “provided” indicates whether a common key and a key label have been provided to the receiver 20 together with count labels. If these pieces of information have already been provided to the receiver 20, a flag “YES” is set, and if not, a flag “NO” is set. Besides, “permitted” indicates whether a right transfer permission has been transmitted in response to a right transfer request from the receiver 20. If a right transfer permission has already been transmitted, a flag “YES” is set, and if not, a flag “NO” is set.

Referring back to FIG. 2, the content transmission connection management module 16 manages connection for transmitting content established between the transmitter 10 and the receiver 20. The authentication/key exchange connection management module 17 manages connection for authentication and key exchange established between the transmitter 10 and the receiver 20. The network I/F processor 18 controls a communication device 108, which will be described later, and performs network processing such as to convert content data, a command, etc. to be transmitted to the receiver 20 into packets.

In the following, the receiver 20 will be described. FIG. 4 is a functional block diagram of the receiver 20. As illustrated in FIG. 4, the receiver 20 comprises a content processor 21, a content-related information processor 22, an encryption processor 23, an authentication/key exchange processor 24, a key/label management module 25, a content transmission connection management module 26, an authentication/key exchange connection management module 27, and a network I/F processor 28.

The content processor 21 outputs content to be dubbed received from the content-related information processor 22 to a display module 104, which will be described later, as well as storing it in the storage module 106.

The content-related information processor 22 feeds content decrypted by the encryption processor 23 to the content supply module 11 such that the content is processed according to information related to the content. Further, the content-related information processor 22 increases the available dubbing count of content to be dubbed by the number of count labels notified by the key/label management module 25.

The encryption processor 23 decrypts encrypted content received from the transmitter 10 using a common key shared with the transmitter 10 through the authentication/key exchange processor 24.

The authentication/key exchange processor 24 performs authentication/key exchange process with the transmitter 10. Besides, if the authentication/key exchange process is successful, the authentication/key exchange processor 24 receives information, such as a common key used to decrypt encrypted content, the key label of the common key, and count labels of the same number as the number of times of dubbing, from the transmitter 10, thereby notifying the key/label management module 25 of the information. Further, upon receipt of a right transfer permission from the transmitter 10, the authentication/key exchange processor 24 notifies the key/label management module 25 of the event.

With respect to content to be dubbed, the key/label management module 25 associates the common key, the key label, and the count labels notified by the authentication/key exchange processor 24 with one another and manages them as content-related information. Further, having notified of receipt of a right transfer permission from the transmitter 10 by the authentication/key exchange processor 24, the key/label management module 25 notifies the content-related information processor 12 of the number of count label contained in the right transfer permission to increase the available dubbing count of the content to be dubbed by the number of the count label.

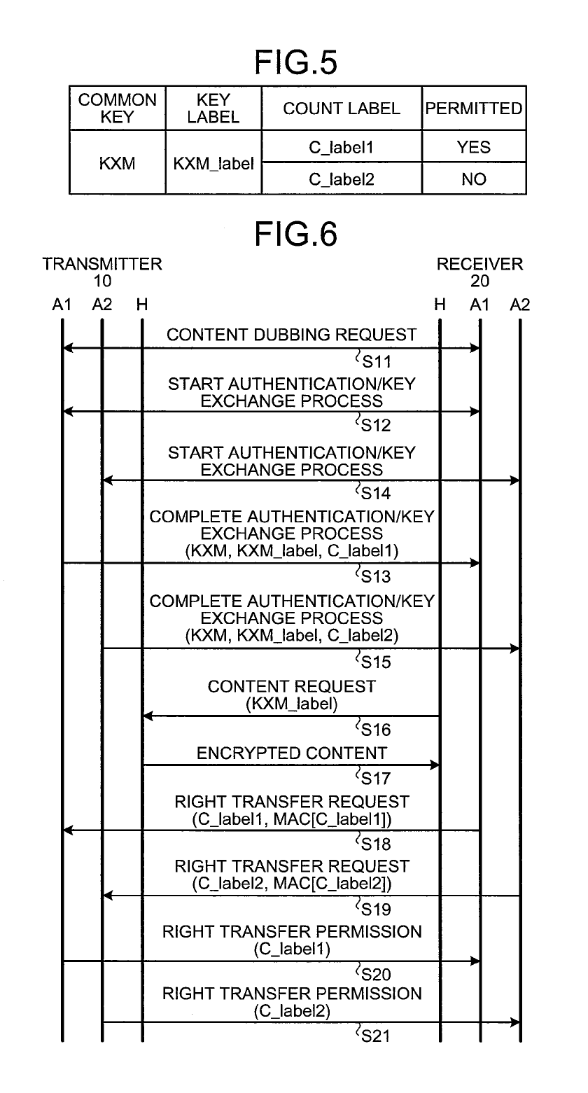

FIG. 5 illustrates an example of content-related information managed by the key/label management module 25. As illustrated in FIG. 5, with respect to content to be dubbed, the key/label management module 25 associates “common key”, “key label”, and “count label” related to the content with one another and manages them as content-related information. Incidentally, the key/label management module 25 may manage the above information further in association with content identification information (for example, content name, etc.) that identifies the content to be dubbed.

In the example of FIG. 5, the same content is dubbed twice, and the key/label management module 25 manages two count labels (C_label1 and C_label2) corresponding to the number of times of dubbing “2”. In FIG. 5, “permitted” indicates whether a right transfer permission has been received from the transmitter 10. If a right transfer permission has already been received, a flag “YES” is set, and if not, a flag “NO” is set.

Referring back to FIG. 4, the content transmission connection management module 26 manages connection for transmitting and receiving content established between the transmitter 10 and the receiver 20. The authentication/key exchange connection management module 27 manages connection for authentication and key exchange established between the transmitter 10 and the receiver 20. The network I/F processor 28 controls the communication device 108, which will be described later, and performs network processing such as to convert a command, etc. to be transmitted to the transmitter 10 into packets.

A description will now be given of the operation of the content transmitting/receiving system of the first embodiment. FIG. 6 is a sequence diagram of an example of the operation of the content transmitting/receiving system. FIG. 6 illustrates an example in which the same content is dubbed twice from the transmitter 10 to the receiver 20, i.e., two rights related to the use of the content are moved or transferred. While, in the example of FIG. 6, communication is performed between the transmitter 10 and the receiver 20 via a connection H for content transmission and connections A1 and A2 for command transmission, it is not so limited.

First, according to an instruction provided from the user of the transmitter 10 or the receiver 20, a request to dub content is transmitted from the transmitter 10 to the receiver 20 (or from the receiver 20 to the transmitter 10) (S11). In response to the request, the authentication/key exchange processor 24 of the receiver 20 starts authentication/key exchange process through the connection A1 for the first dubbing (S12).

After checking that the authentication/key exchange process is successful at S12, the authentication/key exchange processor 14 of the transmitter 10 generates a common key KXM shared as a common secret key to encrypt/decrypt the content between the transmitter 10 and the receiver 20 and a key label KXM_label. The authentication/key exchange processor 14 then transmits the common key KXM and the key label KXM_label to the receiver 20 together with a count label C_label1 for the first dubbing (S13).

Further, the authentication/key exchange processor 24 of the receiver 20 starts authentication/key exchange process through the connection A2 for the second dubbing (S14).

After checking that the authentication/key exchange process is successful at S14, the authentication/key exchange processor 14 transmits the common key KXM and the key label KXM_label generated for content Cl to the receiver 20 together with a count label C_label2 for the second dubbing (S15).

The common key KXM, the key label KXM_label, and the count labels C_label1 and C_label2 transmitted to the receiver 20 as described above are managed by the key/label management module 25 as content-related information as illustrated in FIG. 4. While, in the example of FIG. 6, the authentication/key exchange process through the connection A2 is performed after the authentication/key exchange process through the connection A1, this order may be changed. Further, the authentication/key exchange process through the connection A2 may be performed through the connection A1.

Subsequently, the encryption processor 23 of the receiver 20 obtains the key label KXM_label corresponding to the content to be dubbed from the key/label management module 25. The encryption processor 23 then transmits a content request containing the key label KXM_label to the transmitter 10 through the connection H (S16).

In response to the content request received from the receiver 20, the encryption processor 13 of the transmitter 10 obtains the common key KXM corresponding to the key label KXM_label contained in the content request from the key/label management module 15. The encryption processor 13 encrypts the content to be dubbed received from the content-related information processor 12 with the common key KXM to obtain encrypted content. The encryption processor 13 then transmits the encrypted content to the receiver 20 through the connection H (S17). Incidentally, upon receipt of a request for additional dubbing from the user before the transmission of a right transfer request, which will be described later, the authentication/key exchange process may be additionally performed.

When the receiver 20 receives the encrypted content, the encryption processor 23 decrypts the encrypted content using the common key KXM, and outputs it to the content-related information processor 22. On completion of the transmission/receipt of the content, the key/label management module 25 of the receiver 20 generates a right transfer request, i.e., a request to transfer the right related to the use of the content, with respect to each of the count labels based on the content-related information of the content to be dubbed, and transmits right transfer requests to the transmitter 10 through the connections A1 and A2, respectively (S18, S19). The right transfer requests each contains, in addition to the common key, the key label, and the count label, a MAC value of the count label as information related to the count label. The MAC value is a message authentication code (MAC) of the count label and used to verify the count label. How to calculate the MAC value is not particularly limited, and the MAC value may be calculated by, for example, a commonly known method using a hash function such as SHA-1.

Upon receipt of the right transfer requests from the receiver 20, the key/label management module 15 of the transmitter 10 generates right transfer permissions for the count labels C_label1 and C_label2, respectively, and transmits them to the receiver 20 through the connections A1 and A2, respectively (S20, S21). The right transfer requests and the right transfer permissions may be transmitted using only the connection A1.

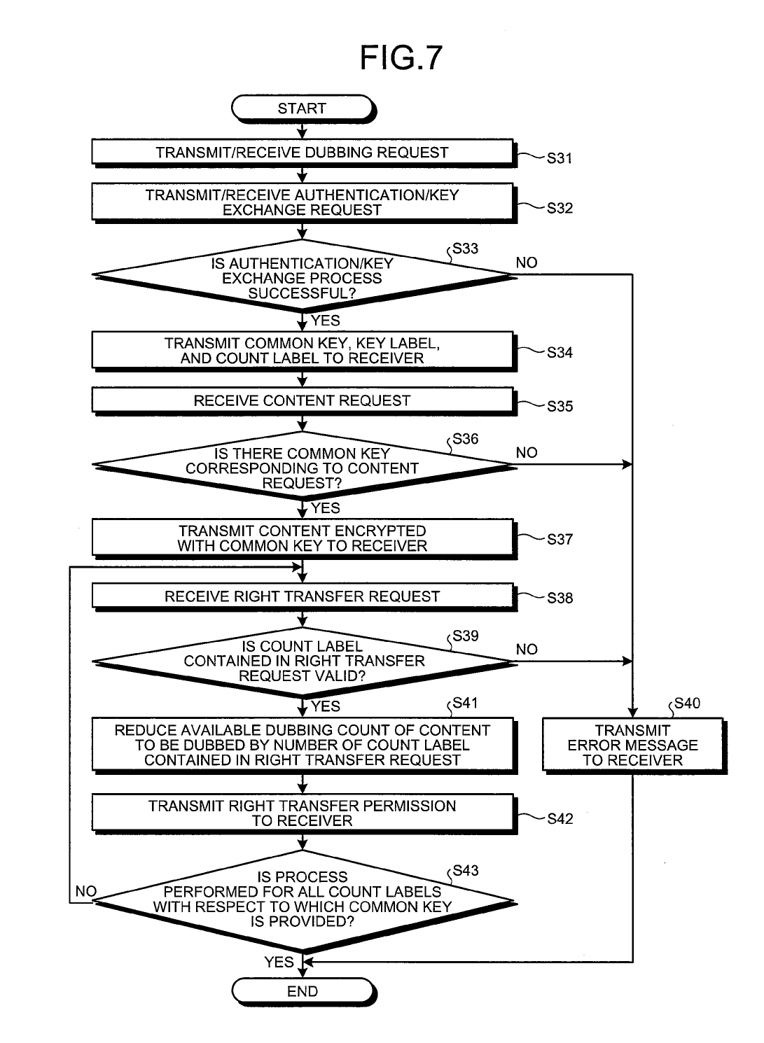

With reference to FIG. 7, the operation of the transmitter 10 will be described. FIG. 7 is a flowchart of an example of the operation of the transmitter 10.

First, the transmitter 10 receives a dubbing request for requesting a specific content from the receiver 20, or transmits a dubbing request for providing a specific content to the receiver 20 (S31). At this point, the content-related information processor 12 notifies the key/label management module 15 of available dubbing count of the content to be dubbed in response to the dubbing request as well as outputting the content to the encryption processor 13.

Thereafter, the authentication/key exchange processor 14 receives an authentication/key exchange request requesting to start authentication/key exchange process from the receiver 20, or transmits an authentication/key exchange request requesting to start authentication/key exchange process to the receiver 20, thereby starting authentication/key exchange process with the authentication/key exchange processor 24 of the receiver 20 (S32). The authentication/key exchange processor 14 determines whether the authentication/key exchange process is successful (S33). Having determined that the authentication/key exchange process has failed (No at S33), the authentication/key exchange processor 14 transmits an error message indicating the failure to the receiver 20 (S40). After that, the process ends.

On the other hand, having determined that the authentication/key exchange process is successful (Yes at S33), the authentication/key exchange processor 14 generates a common key to encrypt the content and a key label of the common key, thereby transmitting them to the receiver 20 together with a count label corresponding to dubbing of this time (S34). The key/label management module 15 associates the common key and the key label generated at S34 and the available dubbing count notified by the content-related information processor 12 with one another, and manages them as content-related information. The key/label management module 15 also sets the flag “YES” for “provided” with respect to the count label transmitted to the receiver 20 at S34.

The authentication/key exchange processor 14 monitors whether an additional dubbing request is received from the receiver 20 until the start of right transfer process (S38), which will be described later. Having received an additional dubbing request, the authentication/key exchange processor 14 starts authentication/key exchange process for the content (S32).

Subsequently, upon receipt of a content request from the receiver 20 (S35), the encryption processor 13 determines whether the key/label management module 15 manages a common key corresponding to a key label contained in the content request (S36). Having determined that the key/label management module 15 does not manage such a common key (No at S36), the encryption processor 13 transmits an error message indicating this to the receiver 20 (S40). After that, the process ends.

On the other hand, having determined that the key/label management module 15 manages the common key (Yes at S36), the encryption processor 13 encrypts the content to be dubbed obtained from the content-related information processor 12 using the common key, and transmits it to the receiver 20 (S37).

Upon receipt of a right transfer request from the receiver 20 (S38), the key/label management module 15 verifies a count label based on the count label and a MAC value contained in the right transfer request (S39). More specifically, the key/label management module 15 calculates the MAC value for verification from the count label contained in the right transfer request using the same hash function as used in the receiver 20. The key/label management module 15 then compares the MAC value for verification with the count label contained in the right transfer request to verify the count label.

When the count label is not valid (No at S39), the key/label management module 15 transmits an error message indicating this to the receiver 20 (S40). After that, the process ends.

On the other hand, when the count label is valid (Yes at S39), the key/label management module 15 notifies the content-related information processor 12 of the number of the count label contained in the right transfer request to reduce the available dubbing count of the content to be dubbed by the number of the count label (S41).

At S41, the available dubbing count is generally reduced by 1. However, if it is defined in advance between the transmitter 10 and the receiver 20 that “one right transfer process indicates two times of dubbing”, the available dubbing count may be reduced by 2 with respect to one count label. Incidentally, if the available dubbing count is 1, the use of the content is disabled (for example, the content is deleted or the like).

Thereafter, the key/label management module 15 transmits a right transfer permission containing the verified count label to the receiver 20 (S42). At this time, the key/label management module 15 sets the flag “YES” for “permitted” with respect to the count label transmitted as the right transfer permission to the receiver 20.

The key/label management module 15 then determines whether the process from S38 to S42 has been performed for all count labels with the flag “YES” being set to “provided” (S43). If there is a count label for which the process is yet to be performed (No at S43), the process returns to S38, and a right transfer request is received from the receiver 20 with respect to the count label. On the other hand, if the key/label management module 15 determines that the process has been performed for all count labels with the flag “YES” being set to “provided” (Yes at S43), the process ends.

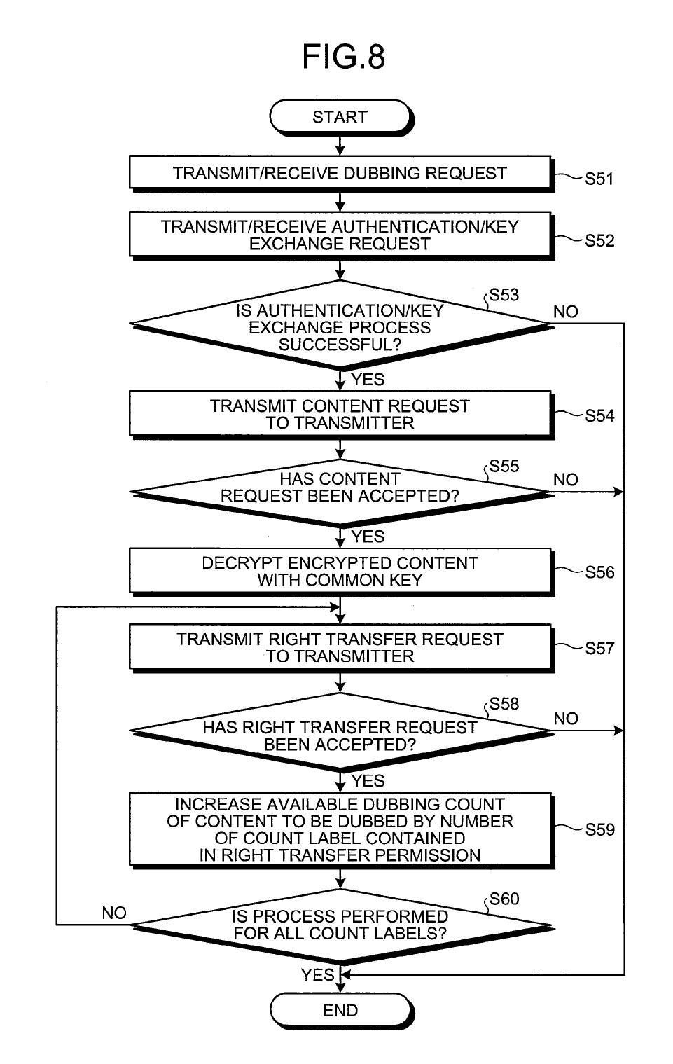

With reference to FIG. 8, the operation of the receiver 20 will be described. FIG. 8 is a flowchart of an example of the operation of the receiver 20.

First, the receiver 20 receives a dubbing request for providing a specific content from the transmitter 10 or transmits a dubbing request for requesting a specific content to the transmitter 10 (S51).

Thereafter, the authentication/key exchange processor 24 receives an authentication/key exchange request requesting to start authentication/key exchange process from the transmitter 10, or transmits an authentication/key exchange request requesting to start authentication/key exchange process to the transmitter 10, thereby starting authentication/key exchange process with the authentication/key exchange processor 14 of the transmitter 10 (S52).

The authentication/key exchange processor 24 determines whether the authentication/key exchange process is successful based on a response from the transmitter 10 (S53). If receiving an error message from the transmitter 10, the authentication/key exchange processor 24 determines that the authentication/key exchange process has failed (No at S53). Thus, the process ends.

On the other hand, if receiving information such as a common key, a key label, and a count label from the transmitter 10, the authentication/key exchange processor 24 determines that the authentication/key exchange process is successful (Yes at S53). Thus, the process proceeds to S54. The key/label management module 25 associates the common key, the key label, and the count label one another, and manages them as content-related information.

The authentication/key exchange processor 24 monitors whether an additional dubbing request is received from the user until the transmission of a right transfer request (S57). Having received an additional dubbing request, the authentication/key exchange processor 24 performs authentication/key exchange process again for the content to be dubbed (S52).

Thereafter, the encryption processor 23 transmits a content request for the content to be dubbed to the transmitter 10 (S54). The encryption processor 23 then determines whether the content request has been accepted based on a response thereto from the transmitter 10 (S55). If receiving an error message from the transmitter 10, the encryption processor 23 determines that the content request has been denied (No at S55). Thus, the process ends.

On the other hand, if receiving encrypted content from the transmitter 10, the encryption processor 23 determines that the content request has been accepted (Yes at S55). The encryption processor 23 decrypts the encrypted content with a common key corresponding to the encrypted content (S56), and then outputs it to the content-related information processor 22.

On completion of receipt of the content, the key/label management module 25 generates a right transfer request containing a count label corresponding to dubbing of this time, the MAC value of the count label, and the like, and transmits the right transfer request to the transmitter 10 (S57). The key/label management module 25 then determines whether the right transfer request has been accepted based on a response thereto from the transmitter 10 (S58). If receiving a right transfer denial from the transmitter 10, the key/label management module 25 determines that the right transfer request has been denied (No at S58). Thus, the process ends.

If receiving a right transfer permission from the transmitter 10, the key/label management module 25 determines that the right transfer request has been accepted (Yes at S58). The key/label management module 25 notifies the content-related information processor 22 of the number of the count label contained in the right transfer permission to increase the available dubbing count of the content to be dubbed by the number of the count label (S59).

At S59, the available dubbing count is generally increased by 1. However, if it is defined in advance between the transmitter 10 and the receiver 20 that “one right transfer process indicates two times of dubbing”, the available dubbing count may be increased by 2 with respect to one count label. Further, upon receipt of the right transfer permission, the key/label management module 25 sets the flag “YES” for “permitted” with respect to the count label contained in the right transfer permission.

The key/label management module 25 then determines whether the process from S57 to S59 has been performed for all count labels that it manages (S60). If there is a count label for which the process is yet to be performed (No at S60), the process returns to S57, and a right transfer request is transmitted to the transmitter 10 with respect to the count label. On the other hand, if the key/label management module 25 determines that the process has been performed for all count labels (Yes at S60), the process ends.

As described above, according to the first embodiment, when content is to be dubbed on one receiver (20) a plurality of times, a common key can be shared among respective dubbings to encrypt/decrypt the content. With this, encryption of the content to be dubbed is required only once. Thus, a transmitter (10) can transmit the content with less resources involved in encrypting the content.

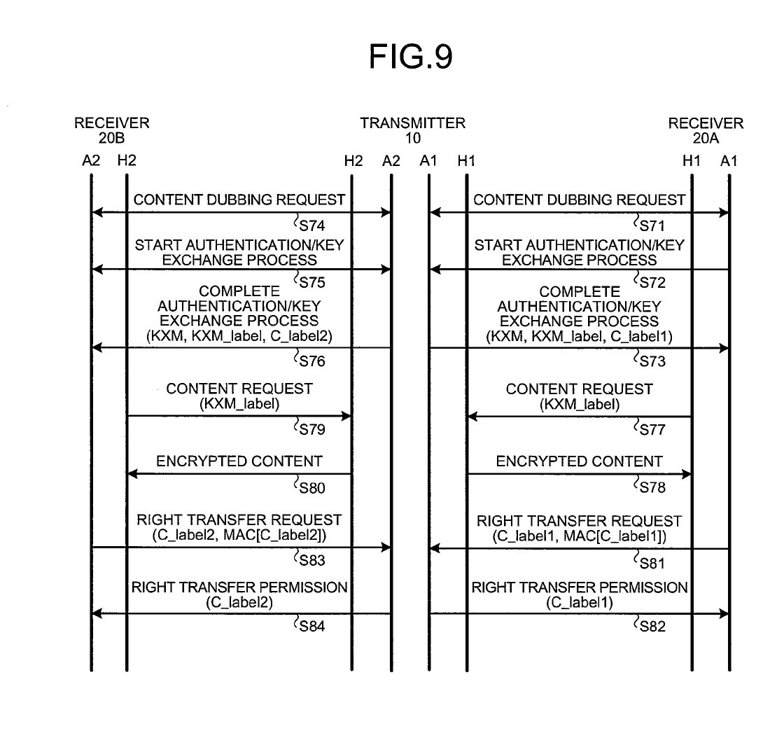

While an example is described above in which one transmitter (10) transmits content to one receiver (20), it is not so limited. Content may be simultaneously dubbed from one transmitter (10) to a plurality of receivers (20). With reference to FIG. 9, a description will be given of an example in which content is simultaneously dubbed from one transmitter (10) to two receivers (20).

FIG. 9 is a sequence diagram of the process of dubbing the same content from the transmitter 10 to two receivers 20A and 20B at once. In the example of FIG. 9, communication is performed between the transmitter 10 and the receiver 20A via a connection H1 for content transmission and a connections A1 for command transmission, while communication is performed between the transmitter 10 and the receiver 20B via a connection H2 for content transmission and a connections A2 for command transmission.

First, according to an instruction provided from the user of the transmitter 10 or the receiver 20A, a request to dub content is transmitted from the transmitter 10 to the receiver 20A (or from the receiver 20A to the transmitter 10) (S71). In response to the request, the authentication/key exchange processor 24 of the receiver 20A starts authentication/key exchange process through the connection A1 (S72).

After checking that the authentication/key exchange process is successful at S72, the authentication/key exchange processor 14 of the transmitter 10 generates a common key KXM used as a common secret key to encrypt/decrypt the content and a key label KXM_label. The authentication/key exchange processor 14 then transmits the common key KXM and the key label KXM_label to the receiver 20A together with a count label C_label1 corresponding to the number of times of dubbing (S73).

In addition, according to an instruction provided from the user of the transmitter 10 or the receiver 20B, a request to dub the content is transmitted from the transmitter 10 to the receiver 20B (or from the receiver 20B to the transmitter 10) (S74). In response to the request, the authentication/key exchange processor 24 of the receiver 20B starts authentication/key exchange process through the connection A2 (S75).

After checking that the authentication/key exchange process is successful at S75, the authentication/key exchange processor 14 of the transmitter 10 generates the common key KXM used as a common secret key to encrypt/decrypt the content and the key label KXM_label. The authentication/key exchange processor 14 then transmits the common key KXM and the key label KXM_label to the receiver 20B together with a count label C_label2 corresponding to the number of times of dubbing (S76).

Thereafter, the encryption processor 23 of the receiver 20A transmits a content request to the transmitter 10 through the connection H1 (S77). The content request from the receiver 20A contains the key label KXM_label transmitted from the transmitter 10 at S73.

In response to the content request, the encryption processor 13 of the transmitter 10 encrypts the content to be dubbed with the common key KXM corresponding to the key label contained in the content request from the receiver 20A to obtain encrypted content. The encryption processor 13 then transmits the encrypted content to the receiver 20A (S78).

Besides, the encryption processor 23 of the receiver 20B transmits a content request to the transmitter 10 through the connection H2 (S79). The content request from the receiver 20B contains the key label KXM_label transmitted from the transmitter 10 at S75.

In response to the content request, the encryption processor 13 of the transmitter 10 encrypts the content to be dubbed with the common key KXM corresponding to the key label contained in the content request from the receiver 20B to obtain encrypted content. The encryption processor 13 then transmits the encrypted content to the receiver 20B (S80).

After that, the key/label management module 25 of the receiver 20A generates a right transfer request based on the content-related information of the content to be dubbed, and transmits it to the transmitter 10 through the connections A1 (S81). Upon receipt of the right transfer request from the receiver 20A, the key/label management module 15 of the transmitter 10 determines whether to accept the right transfer request. Having accepted the right transfer request, the key/label management module 15 transmits a right transfer permission containing the count label C_label1 to the receiver 20A through the connection A1 (S82).

Similarly, the key/label management module 25 of the receiver 20B generates a right transfer request based on the content-related information of the content to be dubbed, and transmits it to the transmitter 10 through the connections A2 (S83). Upon receipt of the right transfer request from the receiver 20B, the key/label management module 15 of the transmitter 10 determines whether to accept the right transfer request. Having accepted the right transfer request, the key/label management module 15 transmits a right transfer permission containing the count label C_label2 to the receiver 20B through the connection A2 (S84).

As described above, when content is to be dubbed on a plurality of receivers, a common key can also be shared among respective dubbings to encrypt/decrypt the content. With this, encryption of the content to be dubbed is required only once. Thus, a transmitter (10) can transmit the content with less resources involved in encrypting the content.

In the following, a second embodiment of the invention will be described. In the second embodiment, an example is described in which a plurality of count labels are shared in one authentication/key exchange process. Constituent elements corresponding to those described in the first embodiment will be designated by the same reference numerals, and their description will not be repeated.

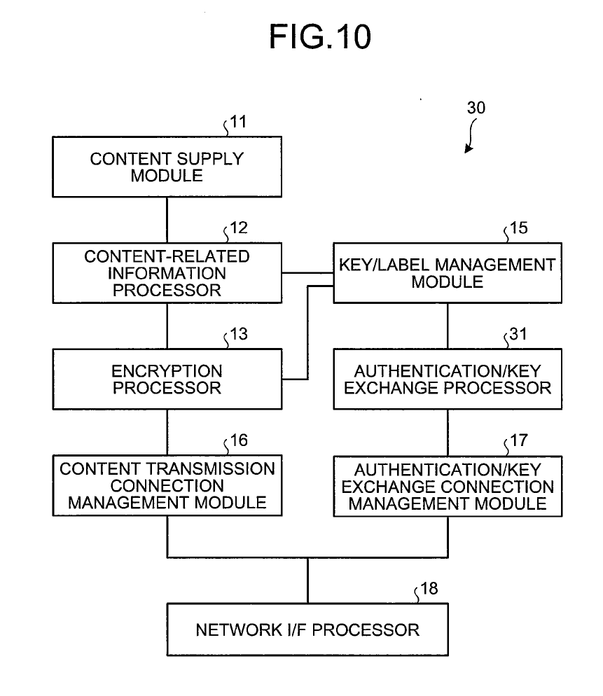

FIG. 10 is a functional block diagram of a transmitter 30 of the second embodiment. As illustrated in FIG. 10, the transmitter 30 comprises the content supply module 11, the content-related information processor 12, the encryption processor 13, an authentication/key exchange processor 31, the key/label management module 15, the content transmission connection management module 16, the authentication/key exchange connection management module 17, and the network I/F processor 18.

The authentication/key exchange processor 31 has the same function as the authentication/key exchange processor 14. Besides, when authentication/key exchange process is successful, the authentication/key exchange processor 31 transmits a common key used to encrypt/decrypt content to be dubbed, a key label of the common key, and count labels of the number corresponding to the number of rights to be transferred to the receiver 20.

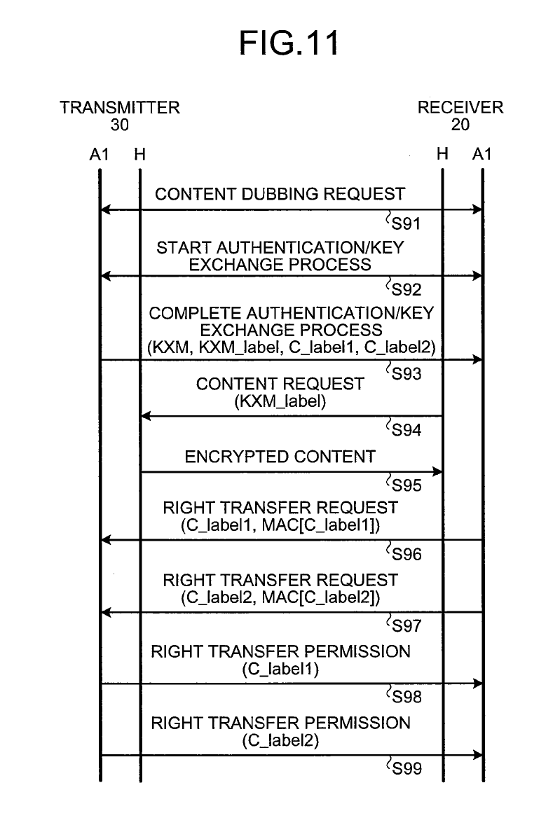

A description will now be given of the operation of a content transmitting/receiving system of the second embodiment. FIG. 11 is a sequence diagram of an example of the operation of the content transmitting/receiving system. FIG. 11 illustrates an example in which the same content is dubbed twice from the transmitter 10 to the receiver 20, i.e., two rights related to the use of the content are moved or transferred. While, in the example of FIG. 11, communication is performed between the transmitter 30 and the receiver 20 via a connection H for content transmission and a connection A1 for command transmission, it is not so limited.

First, according to an instruction provided from the user of the transmitter 30 or the receiver 20, a request to dub content is transmitted from the transmitter 30 to the receiver 20 (or from the receiver 20 to the transmitter 30) (S91). In response to the request, the authentication/key exchange processor 24 of the receiver 20 starts authentication/key exchange process through the connection A1 (S92).

After checking that the authentication/key exchange process is successful at S92, the authentication/key exchange processor 31 of the transmitter 30 generates a common key KXM shared as a common secret key to encrypt/decrypt the content between the transmitter 30 and the receiver 20 and a key label KXM_label. The authentication/key exchange processor 31 then transmits the common key KXM and the key label KXM_label to the receiver 20 together with two count labels C_label1 and C_label2 corresponding to the number of rights to be transferred (S93).

The common key KXM, the key label KXM_label, and the count labels C_label1 and C_label2 transmitted to the receiver 20 as described above are managed by the key/label management module 25 as content-related information as illustrated in FIG. 4.

Subsequently, the encryption processor 23 of the receiver 20 obtains the key label KXM_label corresponding to the content to be dubbed from the key/label management module 25. The encryption processor 23 then transmits a content request containing the key label KXM_label to the transmitter 30 through the connection H (S94).

In response to the content request, the encryption processor 13 of the transmitter 30 obtains the common key KXM corresponding to the key label KXM_label contained in the content request from the key/label management module 15. The encryption processor 13 encrypts the content to be dubbed received from the content-related information processor 12 with the common key KXM to obtain encrypted content. The encryption processor 13 then transmits the encrypted content to the receiver 20 through the connection H (S95). Incidentally, upon receipt of a request for additional dubbing from the user before the transmission of a right transfer request, the authentication/key exchange process may be additionally performed.

When the receiver 20 receives the encrypted content, the encryption processor 23 decrypts the encrypted content using the common key KXM, and outputs it to the content-related information processor 22. On completion of the transmission/receipt of the content, the key/label management module 25 of the receiver 20 generates a right transfer request, i.e., a request to transfer the right related to the use of the content, with respect to each of the count labels based on the content-related information of the content to be dubbed, and transmits right transfer requests to the transmitter 30 through the connection A1 (S96, S97).

Upon receipt of the right transfer requests from the receiver 20, the key/label management module 15 of the transmitter 30 generates right transfer permissions for the count labels C_label1 and C_label2, respectively, and transmits them to the receiver 20 through the connection A1 (S98, S99).

As described above, according to the second embodiment, a plurality of count labels can be provided to the receiver 20 at once. Thus, it is possible to further reduce resources involved in authentication/key exchange process.

In the following, a hardware configuration of the transmitters 10 and 30 and the receiver 20 will be described. The transmitters 10 and 30 and the receiver 20 may be realized by using an information processor such as a hard disk drive (HDD) recorder and a personal computer (PC).

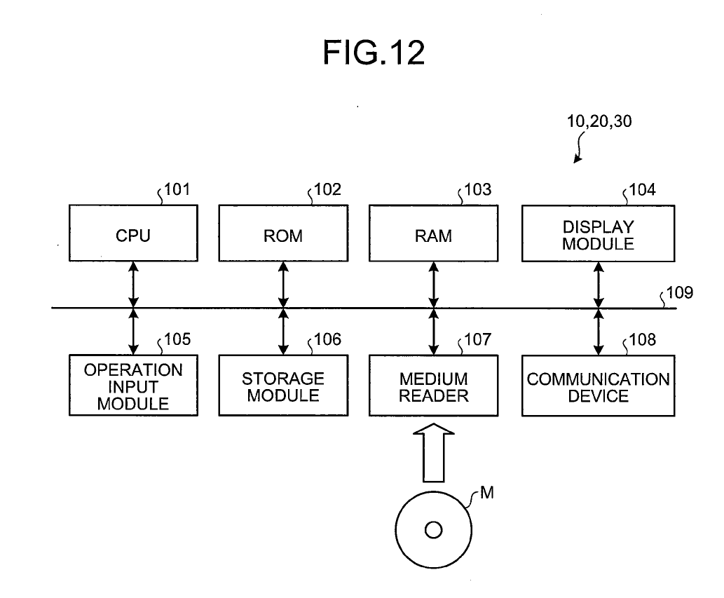

FIG. 12 is a block diagram of a hardware configuration of such an information processor. As illustrated in FIG. 12, the information processor comprises a central processing unit (CPU) 101, a read only memory (ROM) 102, a random access memory (RAM) 103, the display module 104, an operation input module 105, the storage module 106, a medium reader 107, and the communication device 108, which are connected one another by a bus 109. The ROM 102 stores a basic input-output system (BIOS) and the like. The RAM 103 is rewritable and stores various types of data. The display module 104 displays information such as the progress and result of a process for the user. The display module 104 may comprise a cathode ray tube (CRT), a liquid crystal display (LCD), or the like. The operation input module 105 comprises a keyboard and buttons through which the user provides input such as a command and information to the CPU 101. The storage module 106 functions as various types of databases and stores various types of programs. The storage module 106 may be, for example, HDD. The medium reader 107 stores data, distributes data to the outside, and obtains data from the outside using a storage medium M. The medium reader 107 may be, for example, a compact disc-read only memory (CD-ROM) drive. The communication device 108 communicates data with an external device through a communication line.

In the information processor, the CPU 101 loads a program from the storage module 106 into the RAM 103 and executes the program, thereby implementing the various functional modules. In other words, the functional modules of the transmitter 10 or 30 or those of the receiver 20 are implemented by cooperation between the CPU 101 and a program stored in the storage module 106. Depending on the program stored in the storage module 106, the information processor functions as the transmitter 10 or 30 or the receiver 20.

The program is stored in the storage medium M and installed on the storage module 106. Examples of the storage medium M include various types of optical discs such as CD-ROM and digital versatile disc (DVD), various types of magneto-optical disks, various types of magnetic discs such as flexible disk (FD), semiconductor memory, and the like. That is, a portable medium, for example, a magnetic medium such as FD as well as an optical information storage medium such as CD-ROM may be the storage medium M for storing the program. Besides, the program may be obtained from the outside through the communication device 108 and installed on the storage module 106.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A transmitter configured to transmit content to a receiver, available dubbing count being set in advance for the content such that the content can be dubbed a plurality of times, the transmitter comprising:
a key exchanger configured to perform key exchange to share a common key with the receiver, and transmit the common key and at least one count label corresponding to number of times of dubbing to the receiver;
an encryption processor configured to encrypt, in response to a content request for the content received from the receiver, the content with the common key to transmit the content to the receiver; and
a management module configured to reduce the available dubbing count of the content upon each receipt of aright transfer request requesting to transfer right to use the content from the receiver, and transmit permission to the receiver to validate the right to use the content.

2. The transmitter of claim 1, wherein
the content request contains a key label that identifies the common key, and
the encryption processor is configured to encrypt the content with the common key corresponding to the key label contained in the content request.

3. The transmitter of claim 1, wherein
the right transfer request contains the count label, and
the management module is configured to reduce the available dubbing count of the content by a number corresponding to the count label contained in the right transfer request.

4. The transmitter of claim 3, wherein
the right transfer request contains the count label and a message authentication code value to verify the count label, and
the management module is configured to verify the count label based on the message authentication code value contained in the right transfer request, and, only when the count label is valid, reduce the available dubbing count of the content and transmit the permission to the receiver to validate the right to use the content.

5. The transmitter of claim 4, wherein, when the count label is invalid, the management module transmits a message to deny the right transfer request to the receiver.

6. A receiver configured to receive content from a transmitter, available dubbing count being set in advance for the content such that the content can be dubbed a plurality of times, the receiver comprising:
a key exchanger configured to perform key exchange to share a common key with the transmitter, and receive the common key and at least one count label corresponding to number of times of dubbing from the transmitter;
an encryption processor configured to transmit a content request for the content to the transmitter and, upon receipt of the content encrypted by the transmitter from the transmitter, decrypt the content with the common key; and
a management module configured to transmit aright transfer request requesting to transfer right to use the content to the transmitter, and increase the available dubbing count of the content upon each receipt of permission to validate the right to use the content from the transmitter, number of the right transfer request corresponding to number of the count label received by the key exchanger.

7. The receiver of claim 6, wherein
the permission to validate the right to use the content contains the count label, and
the management module is configured to increase the available dubbing count of the content by a number corresponding to the count label contained in the permission.

8. The receiver of claim 6, wherein the management module is configured to generate the right transfer request containing the count label and a message authentication code value to verify the count label with respect to each count label received by the key exchanger.

9. A content transmitting and receiving method applied to a transmitter and a receiver that communicate content, available dubbing count being set in advance for the content such that the content can be dubbed a plurality of times, the content transmitting and receiving method comprising:
the transmitter performing key exchange to share a common key with the receiver, and transmitting the common key and at least one count label corresponding to number of times of dubbing to the receiver;
the transmitter transmitting the content encrypted with the common key to the receiver in response to a content request for the content received from the receiver;
the transmitter reducing the available dubbing count of the content upon each receipt of a right transfer request requesting to transfer right to use the content from the receiver, and transmitting permission to the receiver to validate the right to use the content;
the receiver receiving the common key and the count label transmitted from the transmitter;
the receiver transmitting the content request to the transmitter and, upon receipt of the content encrypted by the transmitter from the transmitter, decrypting the content with the common key; and
the receiver transmitting the right transfer request to the transmitter, and increasing the available dubbing count of the content upon each receipt of permission to validate the right to use the content from the transmitter, number of the right transfer request corresponding to number of the count label received.
